(19) United States
(12) Patent Application Publication
(10) Pub. No.: US 2015/0308169 A1
(43) Pub. Date: Oct. 29, 2015

(54) HEAD-LOCKING DOOR LOCK

(71) Applicant: IREVO, INC., Geumcheon-gu, Seoul (KR)

(72) Inventor: Jung Min LEE, Gyeonggi-do (KR)

(21) Appl. No.: 14/646,173

(22) PCT Filed: Nov. 6, 2013
(86) PCT No.: PCT/KR2013/010015

§ 371 Date: May 20, 2015

(30) Foreign Application Priority Data
Nov. 20, 2012 (KR) 10-2012-0131591

(51) Int. Cl. E05C 3/12; E05B 15/02; E05B 47/00; E05B 15/10

(52) U.S. Cl. CPC E05C 3/12; E05B 15/102; E05B 15/0205; E05B 47/0012; E05C 2003/126; E05B 2047/0072

(57) ABSTRACT

The present invention relates to a head-locking door lock. The door lock includes: a striker including a fixing plate fixed to a door frame and a latch vertically protruding from the fixing plate; and a door lock body including a turning body configured to be rotated with a predetermined radius by a motor, a space portion formed at a front end of the door lock body such that the latch of the striker is positioned therein, and a dead bolt of which one end is connected to the turning body to be moved linearly in the space portion by the rotational movement of the turning body to be engaged with the latch.

### TECHNICAL FIELD

The present invention relates to a head-locking door lock, and more particularly to a head-locking door lock that is prevented from being forcibly unlocked using an instrument from outside.

### BACKGROUND ART

In general, a door lock is widely used in, for example, an ordinary house, an apartment, a company, or an office. Typically, the door lock is used in an entrance door, a safe of a bank, or an access control system for restricting access to a specific area.

The door lock will be briefly described below. FIG. 1 is a view illustrating a conventional door lock.

As illustrated in FIG. 1, the door lock includes a housing 1 installed in a door D, a dead bolt 3 installed reciprocally movable between a locking position A outside the housing 1 and an unlocking position B inside the housing 1, and a driving motor 5 configured to feed the dead bolt 3 between the locking position A and the unlocking position B.

The dead bolt 3 is locked to a locking hole 7a of a striker provided in a door frame D1 while moving forward from the unlocking position B inside the housing 1 to the locking position A outside the housing 1. As a result, the dead bolt 3 serves to lock the door D to the door frame D1.

Further, the dead bolt 3 moves between the locking position A and the unlocking position B while being guided by a guide protrusion 8 provided in the housing 1.

However, such a conventional door lock has a problem in that an intruder from outside can forcibly unlock (so-called nail removing) the door lock by inserting an instrument between the door D and the door frame D1, forcibly widening the gap between the door D and the door frame D1, and then forcibly moving the dead bolt 3 through the widened gap.

### DETAILED DESCRIPTION OF THE INVENTION

### Technical Problem

The present invention has been made in order to solve the problem described above, and an object of the present invention is to provide a head-locking door lock, in which a dead bolt is formed to be engaged and interlocked with a striker having a protruding latch such that a problem of forcible unlocking using an instrument inserted into the door lock from outside can be solved even with a simple structure.

### Technical Solution

In order to solve the problems described above, an embodiment of the present invention provides a head-locking door lock including: a striker including a fixing plate fixed to a door frame and a latch vertically protruding from the fixing plate; and a door lock body including a turning body configured to be rotated with a predetermined radius by a motor, a space portion formed at a front end of the door lock body such that the latch of the striker is positioned therein, and a dead bolt of which one end is connected to the turning body to be moved linearly in the space portion by the rotational movement of the turning body to be engaged with the latch.

The dead bolt is formed in a “⊂” shape so that the dead bolt can be engaged with the latch by being moved in a direction where the dead bolt is introduced into the space portion.

The latch of the striker includes a first bent section perpendicularly bent from the fixing plate, a second bent section perpendicularly bent from the first bent section, and a third bent section inwardly bent from the second bent section so that a locking state can be obtained when the dead bolt is moved to a position surrounded by the first to third bent section.

A reinforcement line convexly protruding on a plane may be formed on the first to third bent sections to improve the strength of the latch.

When the turning body is turned clockwise, the dead bolt may be introduced to be engaged with the latch.

The present invention also provides a head-locking door lock including: a striker mounted on a door frame; a turning body configured to be rotated with a predetermined radius within a door lock body by a driving of a motor; and a dead bolt configured to be introduced into or extracted from the door lock body by being driven by a turning bar that forms a part of the turning body. The dead bolt includes a dead bolt body connected to the turning bar, and a dead bolt head formed in a “⊂” shape on the dead bolt body.

The striker may include a fixing plate configured to be fixed to the door frame, and a latch formed in a part of the fixing plate in a “ [symbol] ” shape.

In addition, the present invention provides a head-locking door lock including a striker installed on a door frame, and a door lock body configured to drive a dead bolt that appears from/disappears into the striker. The striker includes a fixing plate configured to be fixed to the door frame, a latch formed in a “ [symbol] ” shape at a side of the fixing plate, and a turning body configured to rotate with a predetermined radius within the door lock body. The dead bolt is introduced into/extracted from the door lock body by being driven by a turning bar that forms a part of the turning body, in which the dead bolt includes a dead bolt body connected to the turning bar, and a dead bolt head in a “⊂” shape which is configured to be connected with the dead bolt body.

When the turning body is turned clockwise, the dead bolt head of the “⊂” shape of the dead bolt can be engaged with the fixing plate of the striker which is configured to be fixed to the door frame and the latch formed in a part of the fixing plate in the “ [symbol] ” shape so as to achieve a locking state.

The dead bolt body and the dead bolt head may be separately configured and connected to each other, or integrally configured with each other.

In addition, the present invention is provided with a head-locking door lock including a striker mounted on a door frame, and a door lock body mounted on a door. The striker includes a fixing plate configured to be fixed to the door frame, and a latch formed on a part of the fixing plate in a “ [symbol] ” shape.

Furthermore, according to the present invention, there is provided a head-locking door lock including a striker mounted on a door frame, a door lock body mounted on a door, and a dead bolt appearing from/disappearing into the door lock body, the door being opened or closed depending on whether the dead bolt is engaged with the striker. When the door lock is unlocked, the dead bolt of the door lock body protrudes by a predetermined portion from the door lock body, and when the door lock is locked, the dead bolt is introduced into the door lock body by the predetermined portion so that the dead bolt and the striker are engaged with each other.

The striker may include a hook-shaped portion that is engaged with the dead bolt, and the dead bolt may include a space portion formed therein to be engaged with the hook-shaped portion of the striker.

Moreover, according to the present invention, there is provided a head-locking door lock including a striker fixed to a door frame, a door lock body mounted on a door, and a dead bolt appearing from/disappearing into the door lock body. An operation direction of the dead bolt for setting a locking state is formed in a direction from a state where the dead bolt protrudes from the door lock body to a state where the dead bolt is introduced into the door lock body.

The striker may include a hook-shaped portion that is engaged with the dead bolt, and the dead bolt may include a space portion formed therein to be engaged with the hook-shaped portion of the striker.

Moreover, according to the present invention, there is provided a head-locking door lock including a striker fixed to a door frame, a door lock body mounted on a door, and a dead bolt appearing from/disappearing into the door lock body. An operation direction of the dead bolt for setting a locking state is formed in a direction from a state where the dead bolt protrudes from the door lock body to a state where the dead bolt is introduced into the door lock body.

### Advantageous Effects

According to the present invention, the dead bolt is moved with respect to the striker formed with the protruding latch to be engaged with the latch or to be positioned at an openable condition. Thus, the engaged state between the dead bolt and the striker can be prevented from being easily released even when forcible unlocking is attempted from the outside using an instrument (so-called a nail remover), and the rigid engagement force can be maintained only with a simple structure.

### BRIEF DESCRIPTION OF THE DRAWINGS

FIG. 1 is a view illustrating a conventional door lock;

FIG. 2 is a perspective view illustrating a striker and a door lock body of a head-locking door lock according to an embodiment of the present invention;

FIG. 3 is a perspective view illustrating the inside of the striker and the door lock body of the head-locking door lock according to the embodiment of the present invention;

FIG. 4 is a view illustrating the unlocking state of the head-locking door lock according to the embodiment of the present invention;

FIG. 5 is a view illustrating the locking state of the head-locking door lock according to the embodiment of the present invention;

FIG. 6 is a view illustrating the unlocking state of the head-locking door lock according to the embodiment of the present invention, which is viewed from the front side;

FIG. 7 is a cross-sectional view of FIG. 6;

FIG. 8 is a view illustrating the locking state of the head-locking door lock according to the embodiment of the present invention, which is viewed from the front side;

FIG. 9 is a cross-sectional view of FIG. 8; and

FIG. 10 is a view illustrating a configuration of a dead bolt of the head-locking door lock according to the embodiment of the present invention.

### MODE FOR CARRYING OUT THE INVENTION

Hereinafter, a specific embodiment of the present invention will be described in detail with reference to the accompanying drawings.

As illustrated in FIG. 2, a head-locking door lock of the present invention includes a striker 10 mounted on a door frame 100, and a door lock body 20 mounted on a door D.

More specifically, the striker 10 consists of a fixing plate 11 and a latch 12.

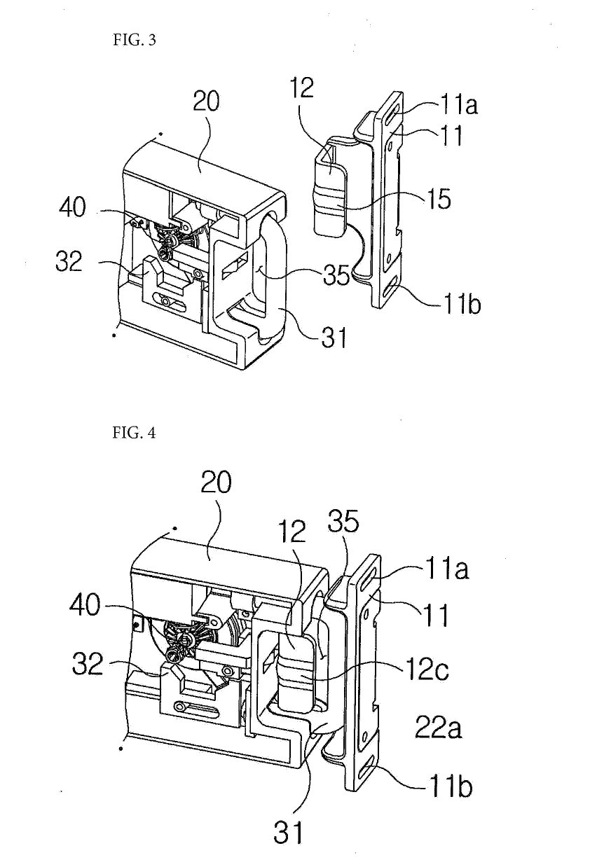

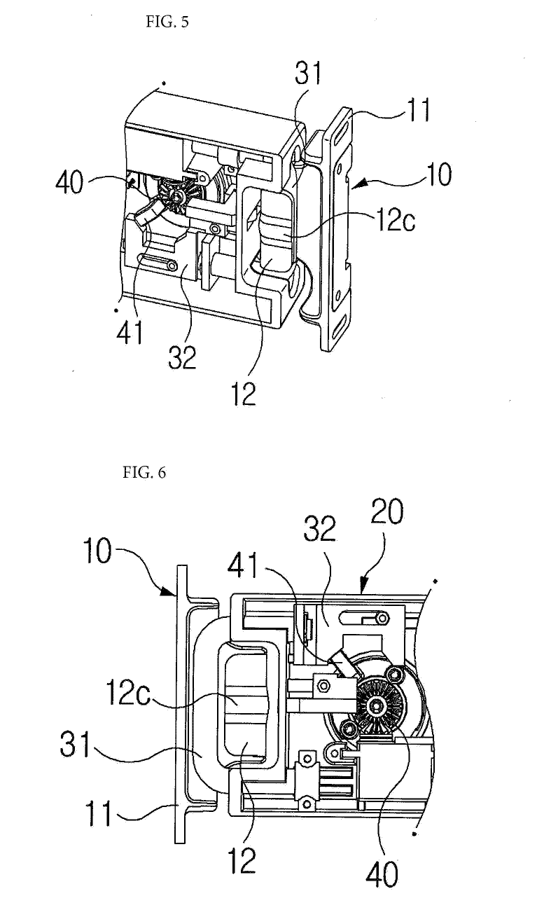

In addition, as illustrated in FIG. 3, the fixing plate 11 of the striker 10 is formed with mounting slots 11a and 11b so as to fix the fixing plate 11 to the door frame 100, and the latch 12 is formed in a shape bent in the form of “ [symbol] ”.

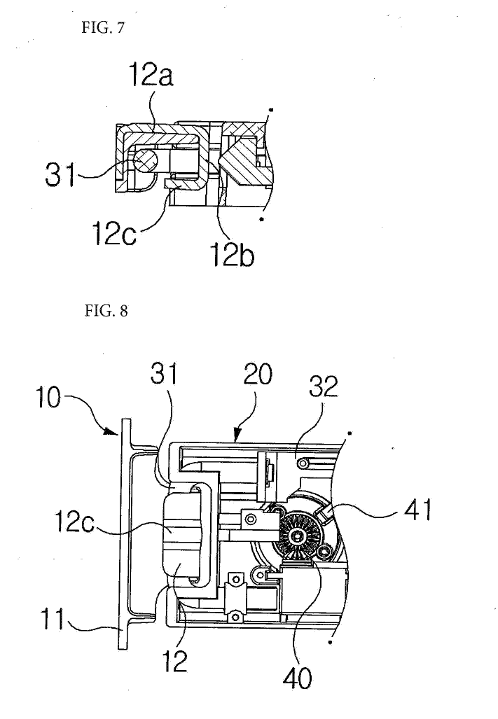

That is, as illustrated in FIG. 7, the latch 12 of the striker 10 takes a form bent in first to third bent sections 12a, 12b, and 12c.

At this time, on the first to third bent sections 12a, 12b, and 12c, a reinforcement line 15 (see FIG. 2) convexly protruding on a plane may be formed. Thus, the reinforcement line 15 serves to reinforce the latch 12 against bending (bending by an external force). Although FIG. 2 illustrates that the reinforcement line 15 is formed all over the first to third bent sections 12a, 12b, and 12c, it is of course that the reinforcement line 15 may be formed on some of the bent sections 12a, 12b, and 12c, and two or more reinforcement lines 15 may be formed.

Meanwhile, the door lock body 20 is provided with a dead bolt 30 configured to be extracted from/introduced into the door lock body 20 by the driving of the motor 5, similarly to the conventional door lock.

Specifically, at the front end of the door lock body 20, a space portion 35 is formed by one side of the door lock body 20 and a dead bolt head 31 that forms a part of the dead bolt 30. The space portion 35 may be provided approximately in a “⊃” shape at the front end of the door lock body 20.

Meanwhile, as the motor 5 is driven, it is of course that the dead bolt head 31 is extracted from/introduced into the door lock body 20 by a predetermined length so that the size of the space portion 35 is changed. In addition, when the latch 12 of the striker 10 is seated in the space portion 35 (when the door is closed to be in contact with the door frame), and then dead bolt head 31 that forms a part of the dead bolt 30 is introduced into the door lock body 20 by a predetermined extent by the driving of the motor, the dead bolt head 31 and the latch 12 are engaged with each other, thereby achieving the locking state of the door lock. That is, the dead bolt 30 is configured to be introduced into the door lock body 20 when the door lock is locked.

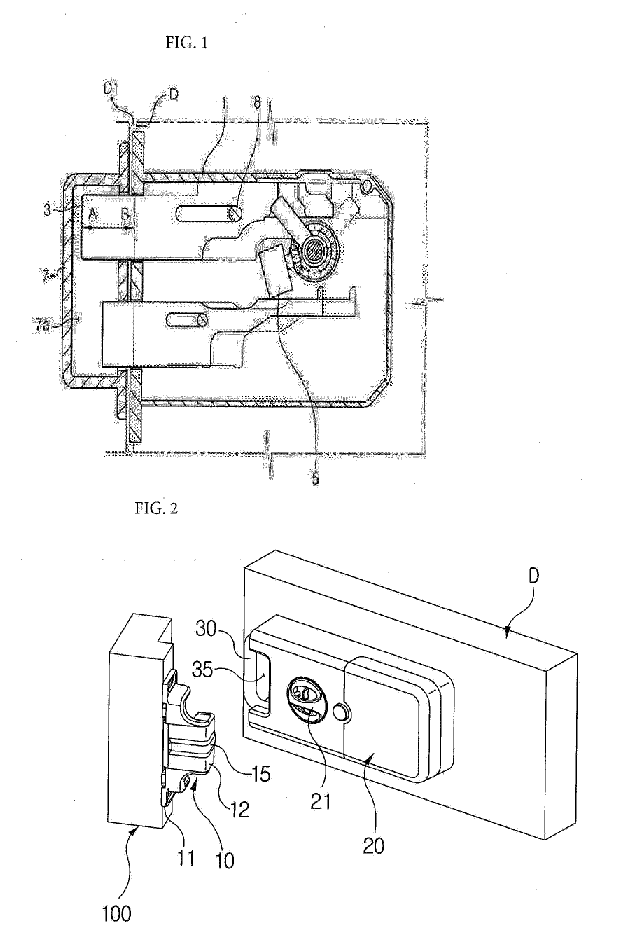

On the contrary, when the motor 5 (see, e.g., FIG. 1) is driven such that the dead bolt 30 (dead bolt head 31) is extracted from the door lock body 20 by the predetermined extent in order to unlock the door lock, the dead bolt head 31 introduced into the door lock body 20 is extracted again from the door lock body 20 by a predetermined portion. Thus, the engagement between the dead bolt head 31 and the latch 12 fixed to the door frame 100 is released so that a user is allowed to open the door (unlocking state). That is, in order to unlock the door lock, the dead bolt 30 is configured to be extracted from the door lock body 20 as the dead bolt 30 is driven by a specific power source such as the motor 5 or the user's manual operation.

As illustrated in FIG. 3, within the door lock body 20, a turning body 40 connected with the motor 5 is formed. As illustrated in FIG. 10, the dead bolt 30 includes a dead bolt head 31 having a “⊂” shape, and a dead bolt body 32 connected with a turning bar 41 of the turning body 40. Thus, the dead bolt head 31 is positioned inside the latch 12 (12a to 12c) of the striker 10.

That is, as illustrated in FIG. 7, the dead bolt head 31 is positioned inside of the bent sections 12a, 12b, and 12c of the latch 12 of the striker 10 to be in a state where the dead bolt head 31 and the striker latch 12 of the striker 10 interfere with each other (locking state (see FIG. 8) or in a free state where the dead bolt head 31 and the striker latch 12 of the striker 10 do not interfere with each other (unlocking state (see FIG. 6) according to the operation of introducing/extracting the dead bolt 30.

Hereinafter, descriptions will be made on a use state of the head-locking door lock of the present invention which is configured as described above.

First, in the unlocking state of the door lock as illustrated in FIG. 6, the turning bar 41 of the turning body 40 pushes out the dead bolt body 32 toward the striker 10 so the dead bolt body 32 is positioned not to interfere with the latch 12. Thus, when the door D is opened, the dead bolt head 31 may be opened forward without interfering with the latch 12 (the dead bolt head 31 may be opened rearward depending on the installation direction of the striker).

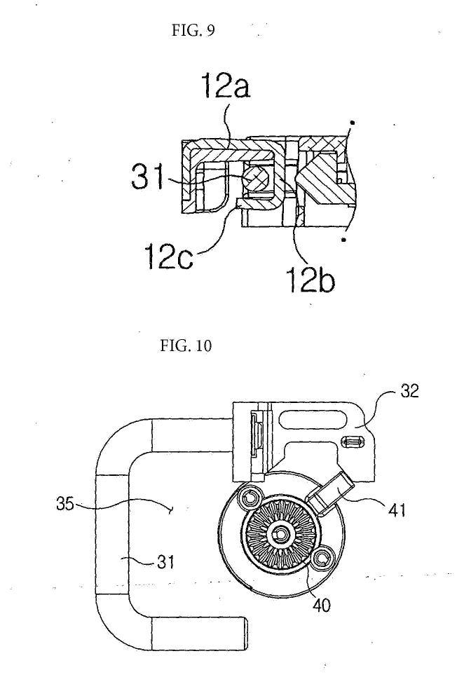

On the contrary, in the case where the turning body 40 is rotated clockwise so that the turning bar 41 moves the dead bolt body 32 inwardly and thus the dead bolt head 31 is positioned inside the latch 12 (that is, in the state as illustrated in FIGS. 8 and 9), the dead bolt head 31 is caught by the third bent section 12c of the latch 12. Accordingly, when it is desired to open the door D, the dead bolt head 31 is restrained by the latch 12 of the striker 10 so that the opening of the door D is impossible (locking state of the door lock). That is, it is impossible to open the door D forward.

In the head-locking door lock of the present invention which is configured and operated as described above, the dead bolt 30 moving inside the striker 10 formed with the protruding latch 12 (inside the latch) is capable of being introduced or extracted to be engaged with the latch 12 or to be positioned at the openable positon. As a result, when forcible unlocking is attempted from outside using an instrument (a nail remover), the engaged state between the dead bolt 30 and the striker 10 can be prevented from being easily released. In particular, by fabricating the dead bolt 30 substantially in the “⊂” shape and the latch 12 in the “ [symbol] ” shape, a rigid engagement force can be maintained only with the simple structure.

Although a specific embodiment of the present invention has been illustrated and described, the present invention is not limited to the embodiment, but it will be appreciated by those skilled in the art to which the present invention pertains that the present invention can be variously modified without departing from the spirit of the present invention which is claimed in the claims.

### INDUSTRIAL APPLICABILITY

The present invention is widely applicable to a conventional door lock device since the dead bolt is moved with respect to the striker formed with the protruding latch so that the dead bolt can be engaged with the latch or positioned at the openable position.

1. A head-locking door lock comprising:
a striker including a fixing plate fixed to a door frame and a latch vertically protruding from the fixing plate; and
a door lock body including a turning body configured to be rotated with a predetermined radius by a motor, a space portion formed at a front end of the door lock body such that the latch of the striker is positioned therein, and a dead bolt of which one end is connected to the turning body to be moved linearly in the space portion by the rotational movement of the turning body to be engaged with the latch.

2. The head-locking door lock of claim 1, wherein the dead bolt is formed in a “⊂” shape so that the dead bolt is engaged with the latch by being moved in a direction where the dead bolt is introduced into the space portion.

3. The head-locking door lock of claim 2, wherein the latch of the striker includes a first bent section perpendicularly bent from the fixing plate, a second bent section perpendicularly bent from the first bent section, and a third bent section inwardly bent from the second bent section so that a locking state is obtained when the dead bolt is moved to a position surrounded by the first to third bent section.

4. The head-locking door lock of claim 3, wherein a reinforcement line convexly protruding on a plane is formed on the first to third bent sections to improve a strength of the latch.

5. The head-locking door lock of claim 2, wherein when the turning body is turned clockwise, the dead bolt is introduced to be engaged with the latch.

6. (canceled)

7. (canceled)

8. A head-locking door lock comprising:
a striker installed on a door frame; and
a door lock body configured to drive a dead bolt that appears from/disappears into the striker,
wherein the striker includes a fixing plate configured to be fixed to the door frame, a latch formed in a “ [symbol] ” shape at a side of the fixing plate, and a turning body configured to rotate with a predetermined radius within the door lock body, and
the dead bolt is introduced into/extracted from the door lock body by being driven by a turning bar that forms a part of the turning body, the dead bolt including a dead bolt body connected to the turning bar, and a dead bolt head in a “⊂” shape which is configured to be connected with the dead bolt body.

9. A head-locking door lock of claim 8, wherein, when the turning body is turned clockwise, the dead bolt head of the dead bolt is engaged with the latch to achieve a locking state.

10. The head-locking door lock of claim 8, wherein the dead bolt body and the dead bolt head are separately configured and connected to each other or integrally configured with each other.

11. A head-locking door lock of claim 1,
wherein the latch of the striker is formed on a part of the fixing plate in a “ [symbol] ” shape.

12. A head-locking door lock comprising:
a striker configured to be mounted on a door frame;
a door lock body mounted on a door; and
a dead bolt appearing from/disappearing into the door lock body so that the door is opened or closed depending on whether the dead bolt is engaged with the striker,
wherein, when the door lock is unlocked, the dead bolt of the door lock body protrudes by a predetermined portion from the door lock body, and when the door lock is locked, the dead bolt is introduced into the door lock body by the predetermined portion so that the dead bolt and the striker are engaged with each other.

13. The head-locking door lock of claim 12, wherein the striker includes a hook-shaped portion that is engaged with the dead bolt, and
the dead bolt includes a space portion formed therein to be engaged with the hook-shaped portion of the striker.

14. A head-locking door lock comprising:
a striker fixed to a door frame;
a door lock body mounted on a door; and
a dead bolt appearing from/disappearing into the door lock body,
wherein an operation direction of the dead bolt for setting a locking state is formed in a direction from a state where the dead bolt protrudes from the door lock body to a state where the dead bolt is introduced into the door lock body.
